(19) United States
(12) Patent Application Publication
(10) Pub. No.: US 2020/0193403 A1
(43) Pub. Date: Jun. 18, 2020

(54) SYSTEMS AND METHODS FOR PROCESSING CUSTOMER PAYMENTS FOR AN ESTABLISHMENT

(71) Applicant: App8 Incorporated, Ottawa (CA)

(72) Inventors: Hani Jabbour, Ottawa (CA); Elias Hage, Ottawa (CA); Ahmed Hammad, Ottawa (CA); Ryan Stephen Smith, Ottawa (CA); Farshad Muhammad, Ottawa (CA)

(21) Appl. No.: 16/711,924

(22) Filed: Dec. 12, 2019

Related U.S. Application Data
(60) Provisional application No. 62/778,606, filed on Dec. 12, 2018.

(51) Int. Cl. G06Q 20/20; G06F 16/23; G06Q 30/04; G06Q 20/32; G06Q 30/06; H04W 4/029; H04W 76/10; H04L 29/08

(52) U.S. Cl. CPC G06Q 20/202; G06F 16/2379; G06Q 30/04; G06Q 20/3224; H04W 88/16; G06Q 30/0641; H04W 4/029; H04W 76/10; H04L 67/306; G06Q 30/0633

(57) ABSTRACT

The present disclosure provides systems and methods for processing customer payments for an establishment. In accordance with some embodiments, a server for processing customer payments for one or more establishments is able to connect to and interface with various establishments' PoS systems (including multiple different kinds of PoS systems) through a network (e.g. the Internet), remotely using cloud application program interfaces (APIs) of the PoS systems. The server is also configured to connect through the Internet to a payment gateway, which may be a software-as-a-service that is remotely available through APIs, for processing customer payments on behalf of an establishment.

### CROSS-REFERENCE TO RELATED APPLICATIONS

This application claims the benefit of U.S. Provisional Patent Application No. 62,778,606, filed Dec. 12, 2018, the entire contents of which is incorporated by reference herein for all purposes.

### TECHNICAL FIELD

The present disclosure relates to processing of customer payments and in particular to interfacing with Point of Sale (PoS) systems of an establishment for processing of the customer payments.

### BACKGROUND

Point of Sale (PoS) systems are used by establishments to track what goods/services customers have ordered and to issue a bill once the customer is ready to pay. Sit-down restaurants or a casual dining restaurant with table service, golf courses, hotel services, etc., are examples of establishments that can utilize PoS systems to associate goods/services with a patron or table during the visit.

FIG. 1 shows a conventional environment for processing customer payments at an establishment. The establishment 100 has an associated PoS system 120 that is used to for tracking customer orders/purchases. Customers 110a-b may order goods/services at the establishment 100, for example through an establishment employee 115 (such as a waiter/waitress, bartender, concierge, etc.) at a table 111, who in turn inputs the order of the goods/services into the PoS system 120.

The PoS system 120 typically comprises a user interface for the employee 115 to interact with the system, shown in FIG. 1 as a computer terminal 122, and a processing device, shown in FIG. 1 as a server 124. In some instances the processing device may itself provide the user interface, i.e. the processing device and the user interface are the same computer component. The processing device is capable of processing payments via a payment processor 126, which may be software or computer-executable instructions that are executed by the processing device, or a stand-alone hardware module comprising computer-readable instructions and that executes the payment processing in association with the processing device.

When a customer 110a-b wishes to leave the establishment they must settle their bill for the goods/services that were ordered. The establishment employee 115 accesses the PoS system to retrieve the customer's bill, the customer settles their bill through their preferred payment method (e.g. cash, credit card), and the employee 115 returns to the PoS system 120 to close the check. If the customer 110a-b pays with cash, the employee 115 deposits the cash into a cash register associated with the PoS system 120. If the customer 110a-b pays with credit card, the employee 115 brings a payment terminal to the customer 110a-b to facilitate the payment, and the payment terminal communicates with the PoS system 120 to process the payment using the payment processor 126.

Existing techniques for processing customer payments at an establishment have several deficiencies, and can result in poor customer experience and less efficient service/establishment operations. One problem is wait time between the moment one or many customers decided they are finished and wants/needs to leave the establishment and the moment they can actually leave once the bill has been settled. Wait times for patrons are especially caused by waiting for a bill, potentially waiting for a payment terminal if a credit or debit card is used to settle the bill, and then paying for the bill. For example, one or more diners may have finished their dinner but they can't leave their table before waiting for a bill and a terminal to pay the bill or a waiter/waitress to give them back change.

Another problem is having establishment resources, physical and human, tied up due to customers trying to settle their bills. For example in a restaurant while the customers are waiting for their bill at the table, the table is occupied and cannot be cleaned, setup and used for new patrons. Some staff members are also busy printing the bill, and bringing the needed payment terminal or change. This is wasted time delaying table turnover during which the table and the staff member are not generating any business in a time that any profit margin improvement is needed.

Accordingly, systems and methods that enable additional, alternative, and/or improved processing of customer payments for an establishment remain highly desirable.

### BRIEF DESCRIPTION OF THE DRAWINGS

Further features and advantages of the present disclosure will become apparent from the following detailed description, taken in combination with the appended drawings, in which:

FIG. 1 shows a conventional environment for processing customer payments at an establishment;

FIG. 2 shows a representation of a system for remotely processing customer payments for a user at an establishment in accordance with the present disclosure;

FIGS. 3A and 3B show methods of how a user uses a mobile application for making payments;

FIG. 4 shows a method of how a profile for a user of the mobile application is created;

FIG. 5 shows a method of testing payment information when a user checks into an establishment;

FIG. 6 shows a method of assigning the user to a session when a user checks-in at an establishment;

FIG. 7 shows a method of responding to a request by a user to cancel a check-in at an establishment;

FIGS. 8A and 8B show a method for tracking a user's order while at an establishment;

FIGS. 9A and 9B show a method of remotely processing a user's payment at an establishment;

FIG. 10 shows a method of processing a collaborative bill payment;

FIG. 11A shows a method of using a user's location to check-in at an establishment;

FIG. 11B shows a method of charging a user that has left an establishment before settling their bill; and

FIG. 12 shows a system for analyzing transaction data.

It will be noted that throughout the appended drawings, like features are identified by like reference numerals.

### DETAILED DESCRIPTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In accordance with one aspect of the disclosure a server for processing customer payments for a plurality of establishments is disclosed, comprising: a communication interface for communicating via one or more communication networks; a memory storing a plurality of user profiles associated with a corresponding plurality of users using a mobile application, and storing establishment profiles for each of the plurality of establishments; and a processing unit configured to: communicate via the communication interface with an electronic device running the mobile application and associated with a user profile among the plurality of user profiles; communicate via the communication interface with native point-of-sale (PoS) systems located at each of the plurality of establishments remote from the processing unit; and communicate via the communication interface with a payment gateway storing user payment information for each of the plurality of users and storing establishment account information for each of at least one establishment of the plurality of establishments.

In some aspects, the server is distributed in a cloud architecture.

In some aspects, the server is configured to receive check-in data of a user at an establishment from the electronic device through the mobile application.

In some aspects, the check-in data is generated from user input or location data.

In some aspects, the server is configured to remotely open a session for the user in the PoS system of the establishment that allows for goods/services ordered by the user at the establishment to be associated with the user.

In some aspects, the server is configured to retrieve session information from the PoS system of the goods/services ordered by the user at the establishment.

In some aspects, the server retrieves the session information in response to user input or from location data indicating that the user has left the establishment.

In some aspects, the server is configured to settle a bill for the goods/services ordered by the user at the establishment by instructing the payment gateway to charge the user a payment to settle the bill and to deposit the payment in an account for the establishment.

In some aspects, the server is configured to: receive a request through the mobile application on the electronic device of a user to settle a bill and information identifying a user's location at an establishment; retrieve session information from the PoS system for sessions associated with the user's location, and provide the session information to the electronic device of the user; receive an indication through the mobile application on the electronic device of the user of a session corresponding to the bill; and instruct the payment gateway to charge the user a payment to settle the bill and to deposit the payment in an account for the establishment.

In some aspects, the information identifying the user's location at the establishment is generated from the user scanning or tapping identification equipment at the establishment using the mobile application.

In some aspects, the server communicates with the native PoS system using one or more APIs for respective PoS systems.

In accordance with another aspect of the present disclosure, a method of processing customer payments for a plurality of different establishments is disclosed, comprising: receiving a request from a mobile application on an electronic device of a user to settle a bill at an establishment; identifying a user profile corresponding to the user and an establishment profile corresponding to the establishment; retrieving session information from a point-of-sale (PoS) system of the establishment indicative of a bill of goods/services ordered by the user at the establishment; and instructing a payment gateway, according to the user profile and the establishment profile, to charge the user a payment to settle the bill and to deposit the payment in an account for the establishment.

In some aspects, the method further comprises: receiving check-in data of the user at the establishment from the electronic device through the mobile application; and remotely open a session for the user in the PoS system of the establishment that allows for the goods/services ordered by the user at the establishment to be associated with the user.

In some aspects, the check-in data is generated from user input or location data.

In some aspects, the received request to settle the bill is generated in response to user input or from location data indicating that the user has left the establishment.

In some aspects, a session is opened for the user in the PoS system is associated with an application tag for the user, and wherein the received request to settle the bill comprises the application tag.

In some aspects, the method further comprises receiving information identifying a user's location at the establishment, and wherein retrieving the session information from the PoS system comprises: retrieving session information from the PoS system for sessions associated with the user's location; providing the session information to the electronic device of the user; and receiving an indication through the mobile application on the electronic device of the user of a session corresponding to the bill.

In some aspects, the information identifying the user's location at the establishment is generated from the user scanning or tapping identification equipment at the establishment using the mobile application.

In accordance with a further aspect of the present disclosure, an integrative point-of-sale (PoS) system for an establishment is disclosed, comprising: an interface for receiving an input of goods/services ordered by customers of the establishment; and a server for processing customer payments for the establishment, comprising: a communication interface for communicating via one or more communication networks; a memory storing a plurality of user profiles associated with a corresponding plurality of users using a mobile application associated with the establishment; and a processing unit configured to: receive the input of the goods/services ordered by customers; and where a customer is a user of a mobile application: communicate via the communication interface with an electronic device of the user running the mobile application; retrieve a user profile from the memory corresponding to the user; and communicate via the communication interface with a payment gateway storing user payment information for each of the plurality of users to instruct the payment gateway to charge the user a payment to settle a bill for the goods/services ordered by the user.

In some aspects, the processing unit is further configured to process customer payments using traditional payment techniques when requested by a user of the mobile application and for customers who are not a user of the mobile application. Other embodiments of this aspect include corresponding computer systems, apparatus, and computer programs recorded on one or more computer storage devices, each configured to perform the actions of the methods.

The present disclosure provides systems and methods for processing customer payments for an establishment. In accordance with some embodiments, a server for processing customer payments for one or more establishments is able to connect to and interface with various establishments' PoS systems (including multiple different kinds of PoS systems) through a network (e.g. the Internet), remotely using cloud application program interfaces (APIs) of the PoS systems. The server is also configured to connect through the Internet to a payment gateway, which may be a software-as-a-service that is remotely available through APIs, for processing customer payments on behalf of an establishment, such as a restaurant. The server configuration provides flexibility for retrieving the goods/services ordered by the customer at the establishment from the PoS system, processing a payment for the goods/services on behalf of the establishment through the payment gateway, and settling/closing the customer's bill at the establishment, without any intervention from an establishment employee. This improves both customer experience by reducing/removing wait times for a customer to settle their bill, and also allows for improved efficiency at the establishment by giving the employee more time for other tasks. In accordance with the embodiments of the present disclosure, the server can interface with native PoS systems without requiring additional hardware solutions to be implemented at an establishment or on the PoS systems (which is both costly and may otherwise require additional employee training). In addition cloud integration helps make the system catastrophe resistant and enables easy migration to different PoS systems.

In accordance with some embodiments, a user, using a mobile device for example, may download an application that communicates with the server. When a user visits an establishment, they can check into the establishment using the application which can be provided to the PoS system. The user can then introduce themselves to the establishment employee and identify that they are using the application. The server is configured to remotely open a session with the native PoS system or to join the user to an already-opened session. The session can be associated with a table or location where the user is. When the user orders goods/services, the establishment employee can input orders into the native PoS system as usual into the open session associated with the customer, identifiable for example by the user's name. When the user of the application, who is a customer of the establishment, wishes to settle their bill and leave, the user may use the application to view and pay for their bill

In restaurants, for example, the embodiments disclosed herein allows customers to walk into a restaurant, order food, eat, and then use the application to pay for their bill and walk out of the restaurant. In the event of a walkout, where a user intentionally leaves the restaurant or forgets to pay the bill by mistake, the embodiments disclosed herein can initiate the bill settlement automatically within a configured amount of time and/or when the customer is a certain distance from the restaurant or at a specific time at night when the restaurant closes.

In other embodiments, a customer of the establishment does not necessarily have to check-in using the application before a PoS system session is opened, or even use the application at all. Location identification can be provided by near field communication (NFC) tags, Bluetooth™ Low Energy (BLE) transmitters, QR™ or barcodes may be dispersed within the establishment at locations associated with PoS system sessions. For example, in a restaurant setting such identification equipment may be arranged at each table. When a user of the application wishes to settle their bill at the end of their meal, they may load the app on their mobile device, tap the NFC card or scan the QR code, and select their bill. The remote server knows which table to retrieve the bills from because the table is associated with the identification equipment, and all bills for the table are presented to the user for selection. Once the user selects their bill, the server can process payment using payment information stored for the user. Additionally or alternatively, a customer need not even be using the application, but rather can open a web page on their device, tap or scan the identification equipment, select their bill, and enter their payment information. Alternatively geo-location services may be utilized to identify the establishment and the user may select their seating position or table to be associated with their bill.

Some of the advantages of the embodiments disclosed herein may increase exponentially with the number of people that are around the same table. With many people around the same table, one or more users can settle their bills simultaneously and all leave the restaurant within seconds of finishing their meals.

The embodiments disclosed herein may also apply at golf courses where the golfers can order drinks throughout their round and use the application to pay whenever they are done and ready to leave without having to worry about spending time to pay every time the drinks cart delivers the drinks or spending time at the end once they are done the round to go up to the staff and settle their bill. The automatic bill settlement also applies.

In stadiums, for example, where lines may be long and get very busy during halftimes or breaks, the disclosed systems and methods can help to streamline the payment action and allow the staff to focus on serving the clients and save precious seconds for each person in line. In accordance with the embodiments disclosed herein patrons can walk up, order, grab their purchases, and leave. The payment can be manually or automatically settled.

Other establishments like nail salons, for example, may take advantage of the automatic payment feature. The customers do not need to reach to their wallets to pay, they can just walk out of the salon and the systems and methods disclosed herein can ensure that the bill is settled without risking ruining the fresh coat of nail polish.

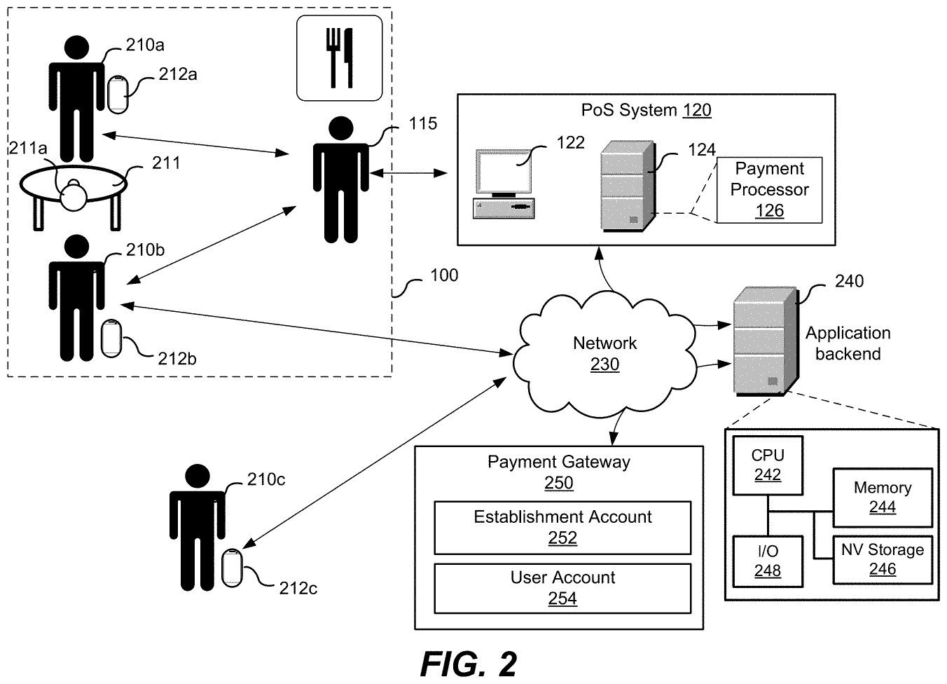

Additional advantages and flexibility provided for by the systems and methods described herein are attainable and are further described below. Embodiments are described below, by way of example only, with reference to FIGS. 2-12.

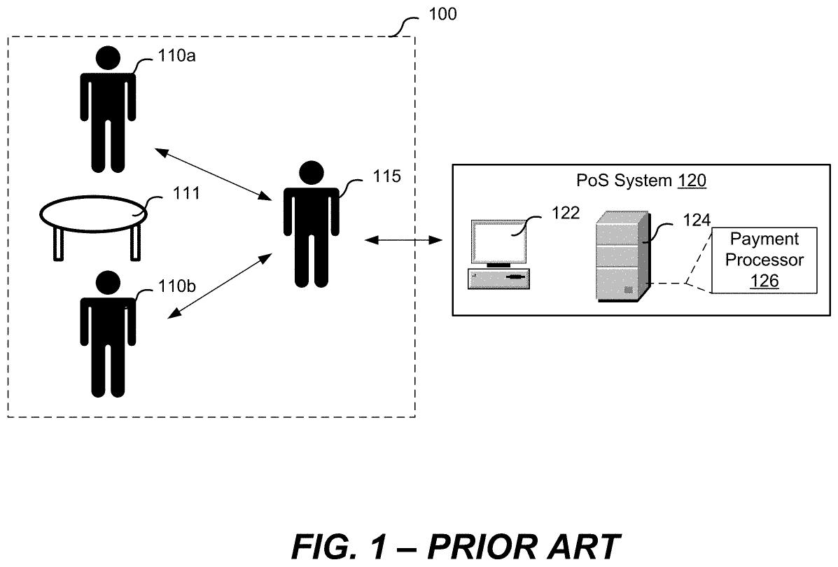

FIG. 2 shows a representation of a system for remotely processing customer payments for a user at an establishment in accordance with the present disclosure. Similar to FIG. 1, customers 210a-b may sit at a table 211 and order goods/services at the establishment 100. The establishment 100 is associated with the same (“native”) PoS system 120 for tracking customer orders/purchases. Customers 210a-b may order goods/services at the establishment 100, for example through the establishment employee 115 who in turn inputs the order/purchase of the goods/services into the PoS system 120.

Some or all of the customers 210a-b may have an electronic device 212a-b running a mobile application that is supported by and communicates with application backend 240 through a network 230 (e.g. the Internet). Users of the mobile application may also include a user 210c with electronic device 212c who is not currently at the establishment 100. The application backend 240 also communicates and interfaces with the native PoS system 120 of the establishment 100 through the network 230, and with a payment gateway 250 which may be operated by a third party, through the network 230, for processing customer payments for the establishment 100.

The application backend 240 may comprise a processing unit, e.g. central processing unit (CPU) 242, a memory 244, non-volatile storage 246, and an input/output interface 248. The input/output interface 248 provides a communication interface that allows for communicating with electronic devices running the mobile application, the PoS system 120, and the payment gateway 250 via one or more networks. The memory 244 and/or non-volatile storage 246 may store a plurality of user profiles associated with a corresponding plurality of users that are using the mobile application. The memory 244 and/or non-volatile storage 246 may also store an establishment profile for the establishment 100. The memory 244 and/or non-volatile storage 246 may further store multiple APIs for communicating and interfacing with the PoS system 120 and PoS systems from different manufacturers.

The processing unit 242, which is configured to execute computer-readable instructions stored on a non-transitory computer-readable memory (e.g. the memory 244) of the application backend 240 for processing customer payments, is configured to communicate with the electronic devices 212a-c running the mobile application, communicate with the native PoS system 120 using APIs for the PoS systems, and communicate with the payment gateway 250 for settling customer payments.

The payment gateway 250 stores establishment account information 252 for the establishment 100 comprising information that allows the customer's payment to be deposited into an establishment's account. The payment gateway 250 also stores user account information 254 comprising user payment information that allows for the user to be charged a payment amount to settle a bill for the goods/services ordered at the establishment 100. In accordance with some embodiments, if the payment gateway 250 is operated by a third party, no financial information of either the application users or the establishments associated with the application backend are maintained at the application backend.

When customers 210a-b that are using the mobile application supported by the application backend 240 on the electronic devices 212a-b enter the establishment, the application backend 240 may determine that the users have checked-in at the establishment. The determination may be made by the user indicating using the mobile application that they have checked-in the establishment. The determination may also or alternatively be made by tracking a location of the electronic devices 212a-b and determining that the user has been at the establishment for a predetermined threshold of time. The determination may still further be made by determining that the electronic device of the user has connected to the establishment's Wi-Fi™ or other network, for example or global positioning system (GPS) location or Bluetooth Low Energy (BLE) beacon can be used to determine the location of the device. The application backend 240 opens a session for the customers 210a-b within the PoS system 120 of the establishment.

The customers 210a-b sit at table 211 and the establishment employee 115 takes their order. The customers 210a-b simply have to introduce themselves by their names and indicate that they are using the mobile application. When the employee 115 returns to the PoS system 120 to input the customers' orders, they can be entered into the open sessions associated with the user's names that were created by the application backend. Each session may be associated with a user's application tag for use by the application backend 240 to correlate the session with the user's profile, and a check ID/seat number for use by the establishment employee to enter the order information. In some embodiments, the user can also be added to a session that is already open—for example if customers are going to split a bill for the goods/services ordered, several users may be added to the same session. A group of customers associated with a session may consist of customers that are all users of the mobile application, or may comprise both customers that are users of the mobile application as well as customers that are not. Alternatively the seating positions may be associated with individual users associated with a table.

During the course of the users' visit at the establishment 100, customers 210a-b may be able to view the items that they have ordered and which have been inputted into the PoS system 120. The application backend 240 can make an API call to the PoS system 120 to retrieve the goods/services attributed to the user's session, and provide this information to the customers 210a-b through the mobile application. Accordingly, if there is an error in the goods/services attributed to a user, the customer can promptly notify the employee 115 well before a bill is printed at the end of the visit.

When the customers 210a-b are finished with their stay at the establishment (e.g. if the establishment is a restaurant, finished their meal) and wish to leave, they may initiate bill settlement through the mobile application. For example, the customer may make an indication through the mobile application that they wish to settle their bill. Additionally or alternatively, the customer may simply leave the establishment and when a location of the electronic device indicates that the user has been outside a geo-fence of the establishment for a predetermined threshold amount of time, or outside a geo-fence of the establishment and a predetermined amount of time has passed since the user last ordered, the application may determine that the user has left the establishment and initiates the bill settlement. The geo-fence for the establishment and/or the threshold amount of time may be generic, or may be specifically configured for the establishment and stored with the establishment profile.

To settle the bill, the application backend 240 makes an API call to the PoS system 120 to retrieve the goods/services ordered by the user while at the establishment. The application backend 240 then instructs the payment gateway to charge the user a payment for the goods/services to settle the bill and to deposit the payment in the corresponding establishment account. The payment charged to the user may be in excess of the amount required to settle their bill in order to pay a fee to the providers of the application backend and/or the payment gateway. Likewise, the payment deposited into the establishment account may be less than the amount required to settle the bill in order to pay a fee to the providers of the application backend and/or the payment gateway.

In another embodiment, the application backend 240 can support bill payments even without the customers' checking-in at the establishment. For example, the establishment may be provided with various identification equipment, such as NFC tag, QR code, or barcode 211a, which can be associated with a location in the establishment 100, such as the table 211, that is associated with PoS systems sessions. Instead of a user checking-in and the application backend 240 opening a session at the PoS system for the user, the employee 115 may open sessions and enter orders in the PoS system 120 as usual, and only when the customer wishes to settle their bill would the application backend 240 find the session for the customer.

In one example, the customer 210a-b may be running the mobile application on their electronic device (smartphone) 212a-b, and when they wish to settle their bill they open the application and tap the NFC tag 211a using their device (other types of identification equipment are also possible, including but not limited to print-outs with QR codes or barcodes, etc.). The application backend 240, based on the location associated with the identification equipment, can query the PoS system 120 to retrieve checks for the table 211 of the establishment. The user may then select their bill using the mobile application and initiate bill settlement. The application backend 240 then instructs the payment gateway to charge the user a payment for the goods/services to settle the bill and to deposit the payment in the corresponding establishment account. In another example, one or more of the customers 210a-b may not have downloaded the mobile application on their electronic device 212a-b. However, the customers may be directed to a webpage and when they wish to view or settle their bill, they can tap the NFC tag 211a using their device. The application backend 240 may host or be configured to receive information from the webpage, and based on the location associated with the identification equipment, queries the PoS system 120 to retrieve checks for the table 211 of the establishment. Within the webpage on their device, the customer may select their bill and enter payment information. The application backend 240 instructs the payment gateway to charge the customer using the payment information provided. Payment may also utilize payment systems such as Apple Pay™, Google Pay™, Samsung Pay™ Venmo™, Interac™ or other 3rd party electronic payment applications.

In the system configuration as described above, the application backend 240 is able to interface with the native PoS system 120 without requiring any hardware modifications to the PoS system 120 at the establishment. Accordingly, payments by customers who are not users of the mobile application and/or do not wish to pay via the webpage may be processed using existing techniques with no change in the procedures of the establishment's employees (e.g. processing credit card payments using a payment terminal and the payment processor).

Additionally, the application backend 240 is able to remotely process customer payments on behalf of the establishment, which may help to provide improved customer experience and reduce tasks needed to be performed by the employee 115. The application backend 240, being remote from the PoS system 120 and establishment 100, e.g. distributed in a cloud architecture, also helps to improve the reliability of processing customer payments. For example, in the event of a minor or catastrophic situation at the establishment 100 such as a fire, flood, electrical outage, etc., customer payments can still be processed on behalf of the establishment for those customers who are users of the mobile application.

Although only one establishment 100 and PoS system 120 is shown in FIG. 2, a person skilled in the art would appreciate from the disclosure herein that the configuration and cloud-integration of the application backend 240 allows for processing customer payments for multiple establishments, each having respective PoS systems, including PoS systems running different APIs. The APIs may be selected during configuration or dynamically determined by the application backend for each associated PoS system.

The application backend 240 can use a set of APIs that can be conformed to different APIs for the various PoS systems with which the application backend interfaces with. In some embodiments, the application backend 240 may communicate with the PoS system through some or all of the following APIs: Create Check, AddGuestToCheck, GetGuestItems, GetChecksByTable, and MakePayment for each specific PoS manufacturer. The CreateCheck API may be used to create a check in the PoS and returns a Check Identifier. The Check will have a seat or a guest that will have an item or an attribute that represents the user's application Tag. The AddGuestToCheck API may be used where the PoS supports multiple guests on the same check to allow a guest to be added to a new seat on the that Check. The new seat or guest will have an item or an attribute that represents the user's application Tag. The GetGuestItems API may allow for querying/retrieving from the PoS the item list that were ordered by the person represented by a particular application tag and/or a particular check id and a seat number. The GetChecksByTable API may allow for querying/retrieving from the PoS the checks for a particular table/location (e.g. where an application tag or particular check id/seat number is not known). The MakePayment API may be used to mark that a payment is made with the specified amount against the check and seat of the person that is represented by the user's application Tag, or alternatively mark that a payment is made with the specified amount against the check id and seat number.

The functionality of the application backend 240 is also not limited to that which has been described above and the application backend may be configured to provide further services to the establishment 100 and the users of the mobile application.

For example, the application backend 240 may provide for display in the mobile application a list of nearby restaurants based on the user location that are participating with the application backend 240.

The application backend 240 may also be able to notify users of the mobile application for various reasons. As an example, the user 210c may be notified when they approach the establishment 100 that it is a participating establishment.

The application backend 240 may be configured to apply automatic discounts to a user's bill and make sure that it is reflected in the PoS. For example a $5 discount may be applied every time a user spends more than $20 at a specific establishment. This can be configurable by the establishment owners to allow them to create promotions easily and apply them automatically without any effort from the staff. An ApplyDiscount API may be utilized to apply a percentage or an amount discount to a session associated with a user's application tag or with the check ID and the seat number. Further, if an establishment is offering discounts to a certain demographic, organization or group (e.g. people living within a certain geographic area, companies, or sports teams), the application backend 240 can determine whether to apply this discount based on information known about users. The application backend can also pre-populate user accounts whereby if a new user that is part of the target demographic signs up for an account using the application then the discount is already associated with their account.

Additionally, given a set of conditions a note can be added in the PoS on a specific check. For example a note to add a ‘nachos’ on the table every time all the application users on a table that collectively spend more than $20 at a specific establishment. This can be configurable by the restaurant owners to allow them to help the staff remember to apply certain promotions.

Further, the application backend may feed transaction data into an analytics engine to analyze data for the establishment. The analytics may be particularly relevant to data generated from users of the application, but some analytics can also be obtained from transaction data of customers' who choose to settle their bills through the webpage. The analytics may be reported to the establishment to provide information on metrics such as: revenue, number of guests, transactions over time, average time spent at restaurant, average tip, average bill amount, top ordered items, transactions per day, transactions per week, dollars per day, dollars per hour, etc. Predictive analytics may also be used to provide the establishments with data analysis that allows them to improve their sales and insight into the health of the business that can provide explanations on certain criteria through Anomaly Detection algorithms. User data may also be correlated across different restaurants as long as there is no sharing of direct restaurant or user data across unrelated restaurants. The anomaly detection algorithms can be used to identify problems with a menu item, problems with a particular time of day, problems with a waiter/waitress, etc. The analytics engine may also provide actions that the establishments can take based on the analysis, for example, change item price, remove item, let go of a waiter, open later, close earlier, close later, etc. Moreover, guest behaviour can be predicted and actions can be provided to the establishment that may help to improve the restaurant's business through algorithms that do Sentiment analysis and Forecasting, such as predicting when the guest is going to visit next, what items the customer is likely to order next time they visit, how much would the guest pay, etc. Further, the analytics engine can determine actions that the establishment can take base on the predicted guest behaviour, such as who to target (based on item preference, expected visit date, expected spend), what to target them with, when to target, etc. For example, the analytics engine may identify the correlation between different menu items to allow the staff to successfully upsell. For instance it may be detected that there is a high probability a user gets a brownie for dessert when a user orders a chicken burger. A restaurant may be provided with that information so that they can instruct their staff to suggest the brownie every time a person orders a chicken burger to get a more successful up-sell.

In still a further embodiment, the outputs from the analytics engine can be provided through the application back-end to the PoS system directly. For example, the analytics engine may determine that user A typically orders a salad at restaurants that they visit. When the user checks-in at an establishment, this insight of the user's preference to eating salad may be provided to the employee of the establishment, better allowing them to prepare in advance for their interaction with the customer and possible questions that may be asked or with recommendations.

It is believed that a person skilled in the art would readily appreciate that the configurability and flexibility provided by the systems and methods disclosed herein offer many advantages, and that the systems and methods may be used to provide further functionality without departing from the scope of this disclosure.

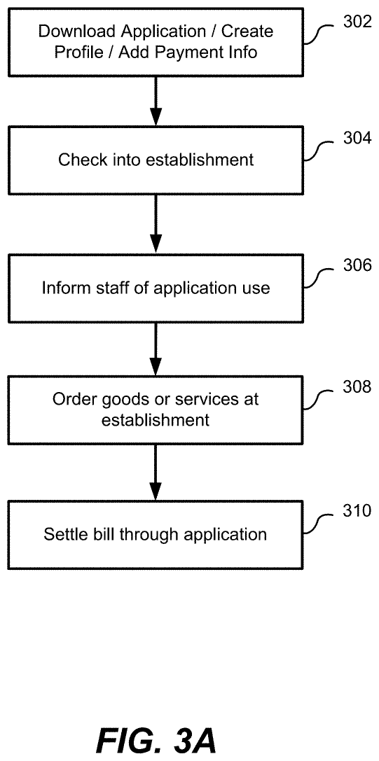

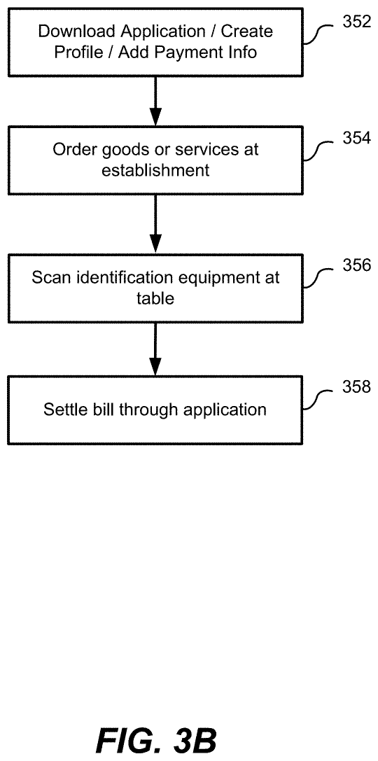

Additionally, while FIG. 2 shows the application backend 240 being remote from the PoS system 120 and connected through network 230, in some embodiments the processing device of the PoS system (e.g. server 124) may be replaced or complimented by the application backend 240. That is, an integrative PoS system for an establishment may be implemented at the establishment. While some advantages described in the configuration of FIG. 2 are attained by having the application backend 240 remote from the PoS system, much of the functionality of the application backend 240 as described can also be provided by such an integrative PoS system for an establishment and certain advantages (such as a user being able to initiate bill settlement through an application without notifying the establishment employee, for example) can still be attained. An integrative PoS system may be implemented where an establishment wishes to have a dedicated mobile application. In comparison, having the application backend 240 remote from the PoS system 120 and configured to interface with many PoS systems of different establishments as described with reference to FIG. 2 may support a single application that the different establishments participate with. The methods described with regards to FIGS. 3 thru 11 may be relevant to both a system comprising the application backend 240 as well as an integrative PoS system.

FIGS. 3A and 3B show methods of how a user uses a mobile application for making payments. In FIG. 3A, a user downloads the mobile application and creates a user profile, which involves adding payment information (302). The user checks into an establishment that is participating with the mobile application (304). As described with reference to FIG. 2, the application backend 240 may have stored, in memory, an establishment profile for the establishment and the payment gateway may store establishment account information. As also described with reference to FIG. 2, the user checking into the establishment may be determined for example by the user indicating using the mobile application that they have checked-in; a location of the user as received from the mobile application indicating that the user has been at the establishment by location information for a predetermined threshold amount of time; and/or the user's device connecting to a local network of the establishment.

The user of the application informs the establishment staff that they are using the application (306). The user orders good/services at the establishment (308). The user settles their bill through the application (310). As described with reference to FIG. 2, the user may indicate that they wish to settle their bill by indicating, using the mobile application, that they would like to settle the bill. Additionally or alternatively, the user may simply leave the establishment and bill settlement can be initiated when a user has been outside a geofence of the establishment for a predetermined threshold amount of time, or outside a geofence of the establishment and a predetermined amount of time has passed since the user last ordered.

In the method shown in FIG. 3B, a user can settle their bill without checking into the establishment prior to ordering. A user downloads the mobile application and creates a user profile, which involves adding payment information (352). The user orders good/services at the establishment (354). When the user has finished their meal and wishes to initiate bill settlement, they may scan or tap identification equipment located where they are seating (356). The user settles their bill through the application (358).

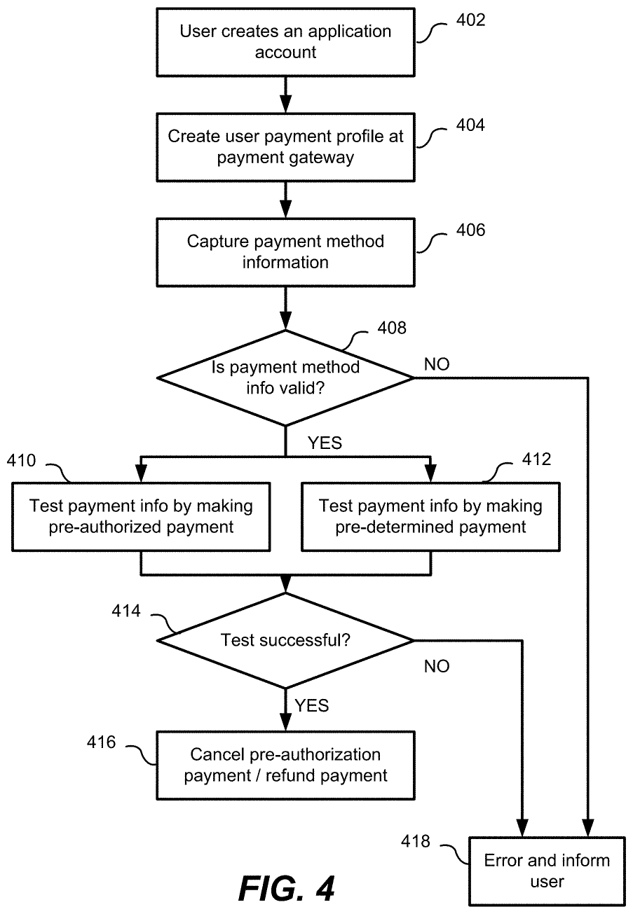

FIG. 4 shows a method of how a profile for a user of the mobile application is created. A user creates an account for the mobile application (402). The application backend 240 may receive user profile information that the user has provided upon creation of the account, such as user sign-in information (username and password, or sign-in with social media account, etc.), and user information such as name, age, date of birth, email address, phone number, etc.

A user payment profile is created at the payment gateway (404). The application backend 240 may communicate some of the user profile information to the payment gateway 250 for use in creating the payment profile. Payment method information for the user is captured (406). The payment method information may for example comprise a credit card number and expiration date. A determination is made if the payment method information is valid (408). For example, a logical and semantical validation such as the number of characters in the credit card number or the expiration date may be used to validate the payment method information. If the payment method information is not valid (NO at 408), the application backend returns an error and informs the user (418).

If the payment method information is valid (YES at 408), the payment information is tested by making either a pre-authorized payment (410) or a pre-determined payment (412). A determination is made if the test is successful (414). If the test is successful (YES at 414) the pre-authorization payment is cancelled and/or the pre-determined payment is refunded (416). If the test is not successful (NO at 414) the application backend returns an error and informs the user (418).

While the present description refers to credit card information, it should be understood that the payment method information is not limited to such. For example, crypto currencies may also be supported, and the application backend can integrate with digital payment gateways.

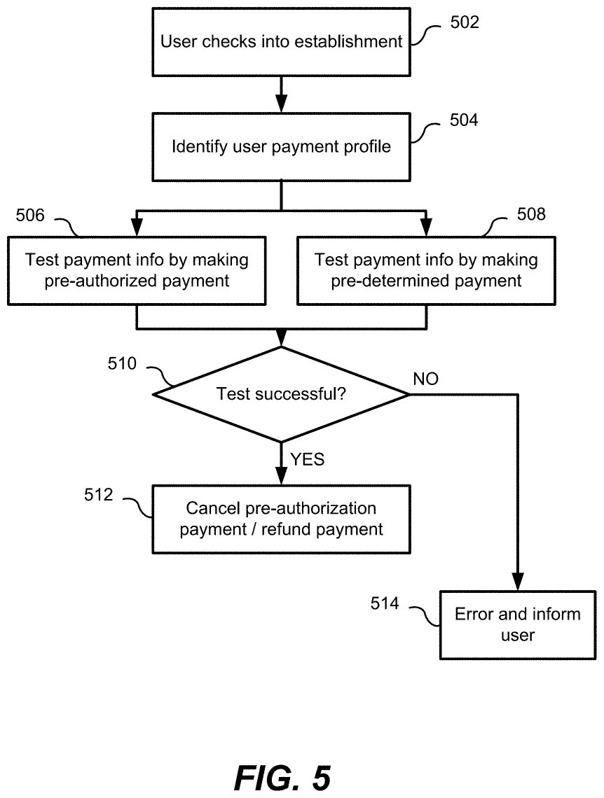

FIG. 5 shows a method of testing payment information when a user checks into an establishment. Each time that a user of the mobile application checks into an establishment the payment information associated with the user account may be verified. This way, if a user chooses to initiate bill settlement at the end of their visit by walking out of the establishment, the application backend can confirm before the user orders goods/services that the payment information is still valid and can be used to charge the user for any goods/services ordered.

It is determined that the user checks into an establishment (502). The user payment profile is identified (504). Using the payment information associated with the user payment profile, the payment information is tested by making one of a pre-authorized payment (506) or a pre-determined payment (508). A determination is made if the test is successful (510). If the test is successful (YES at 510) the pre-authorization payment is cancelled and/or the pre-determined payment is refunded (512). If the test is not successful (NO at 510) the application backend returns an error and informs the user (514). In some instances, the user may also be flagged for attempting to use the service without being able to pay or having invalid payment information, and the user may be prevented from using the service until a valid form of payment is added.

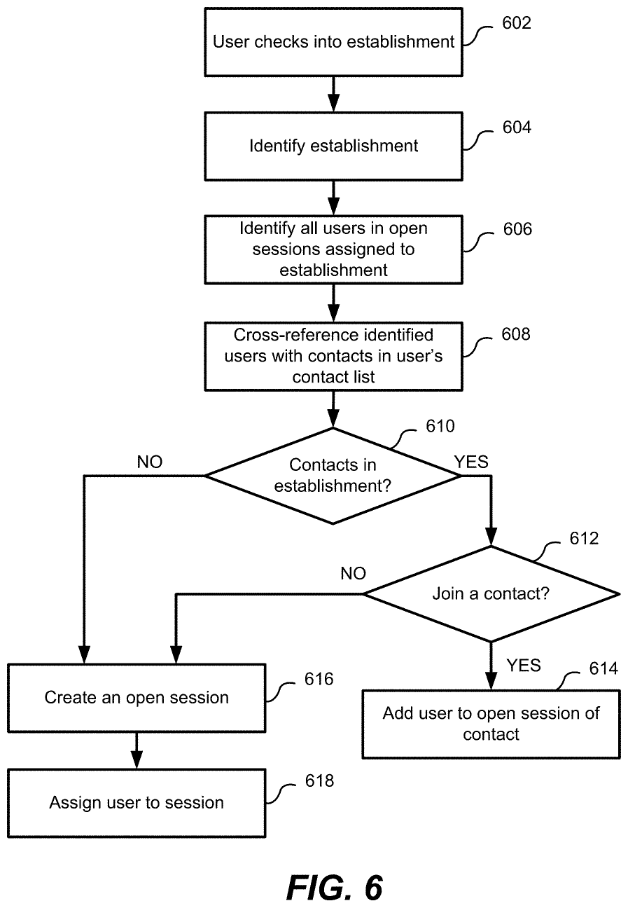

FIG. 6 shows a method of assigning the user to a session when a user checks-in at an establishment. It is determined that the user checks into an establishment (602). The establishment is identified (604). For example, the establishment may be identified from check-in information inputted into the application by the user. Additionally or alternatively, the establishment may be identified by the location of the user's electronic device running the application.

The application backend identifies all users in open sessions assigned to that established (606). The PoS system may be queried to determine all the users in open sessions at the restaurant. The contact list of the user that has checked-in is cross-referenced against the identified users in open sessions assigned to that establishment (608). A determination is made if there are contacts of the user assigned to an open session at the establishment (610). If there is a contact of the user assigned to an open session at the establishment (YES at 610) the user is presented with an option to join the contact (612). If the user wishes to join the contact (YES at 612) the user is added to the open session of the contact (614). If the user does not wish to join the contact (NO at 612) the application backend creates an open session in the PoS system (616) and the user is assigned to the open session (618). If there is not a contact of the user assigned to an open session at the establishment (NO at 610) the application backend creates an open session in the PoS system (616) and the user is assigned to the open session (618).

Each session may be associated with a user's application tag for use by the application backend 240 to correlate the session with the user's profile, and a check ID/seat number for use by the establishment employee to enter the order information. When the application backend opens a session for a user, the user's name may be provided to the PoS so that the establishment employee can associate the user's session with the check ID/seat number.

The above-described method provides a particular implementation of assigning a user to a session at the establishment upon check-in that involves cross-referencing contact information with users in open sessions assigned to the establishment. It would be well appreciated that this method could be modified without departing from the scope of this disclosure. For example, in some embodiments a user may simply be assigned to an open session without the application backend checking for contacts at the establishment. In some embodiments a user may have to indicate that there are contacts at the establishment with whom they wish to join for the backend to retrieve users in open sessions at the establishment.

In still further embodiments, a user may join friends at an establishment by the backend providing the user with a full list of application users at the establishment, however the user may only see unmasked names if that user has been at a table with the user before or if the phone number associated with that user profile is in the user's contact list or the email associated to their user profile is in the user's contact list. Otherwise the user may only see the masked name, which might only displays that user's initials for example. With such a feature, if a user is joining someone that works with them, or someone that they don't know very well, the user may not have their phone number and may not have been at a table with them before. The user may then look for that person's initials in the masked list of names, and may still join them without compromising the privacy of the rest of the guests that are at the establishment that are also not in the user's contact list.

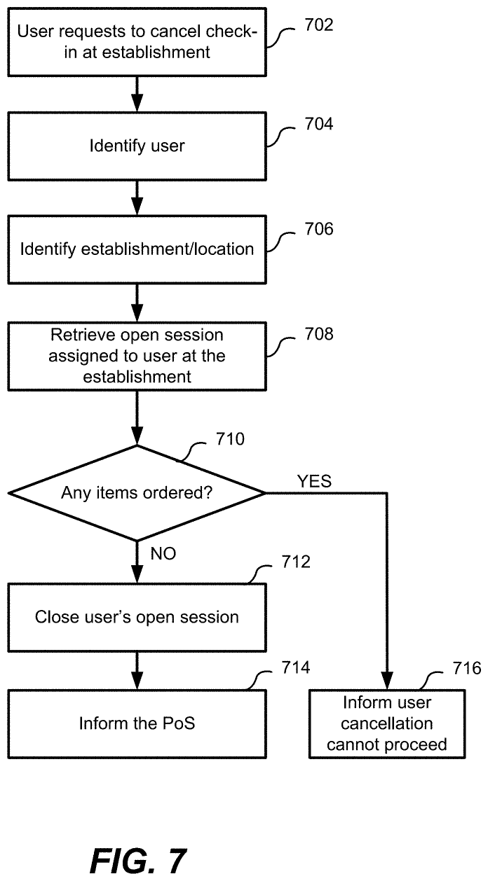

FIG. 7 shows a method of responding to a request by a user to cancel a check-in at an establishment. The application backend receives a user request to cancel a check-in at an establishment (702). The user is identified (704) and the establishment is identified (706). Information from the open session assigned to the user at the established is retrieved from the PoS system at the establishment (708). A determination is made if any items are ordered (710). If no items have been ordered (NO at 710), the open session assigned to the user is closed (712) and the PoS is informed (714). If items have been ordered by the user (YES at 710) the user is informed that cancellation cannot proceed (716).

In some embodiments, the user may also be able to cancel check-in externally, for example by informing the staff at the establishment that they have checked-in to the establishment using the application but wish to cancel their check-in. The establishment employee may then close the session at the PoS. The application backend would thus be unable to retrieve an open session assigned to the user at the establishment.

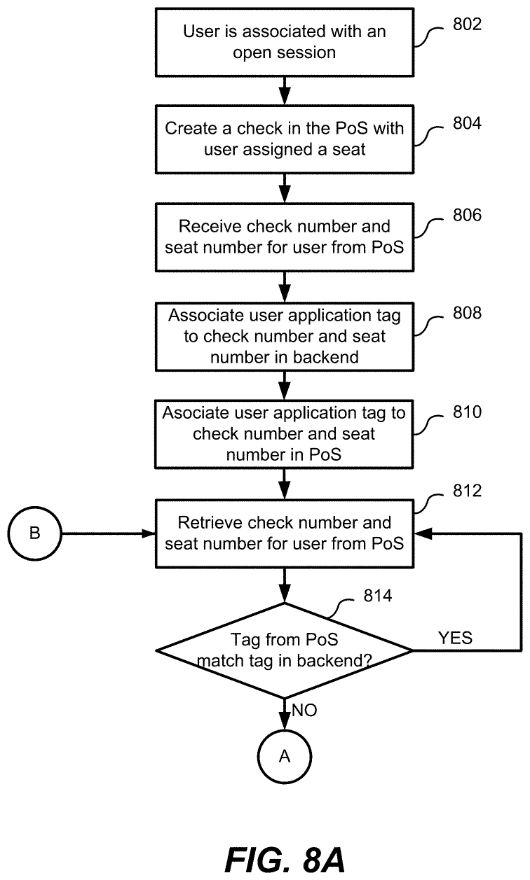

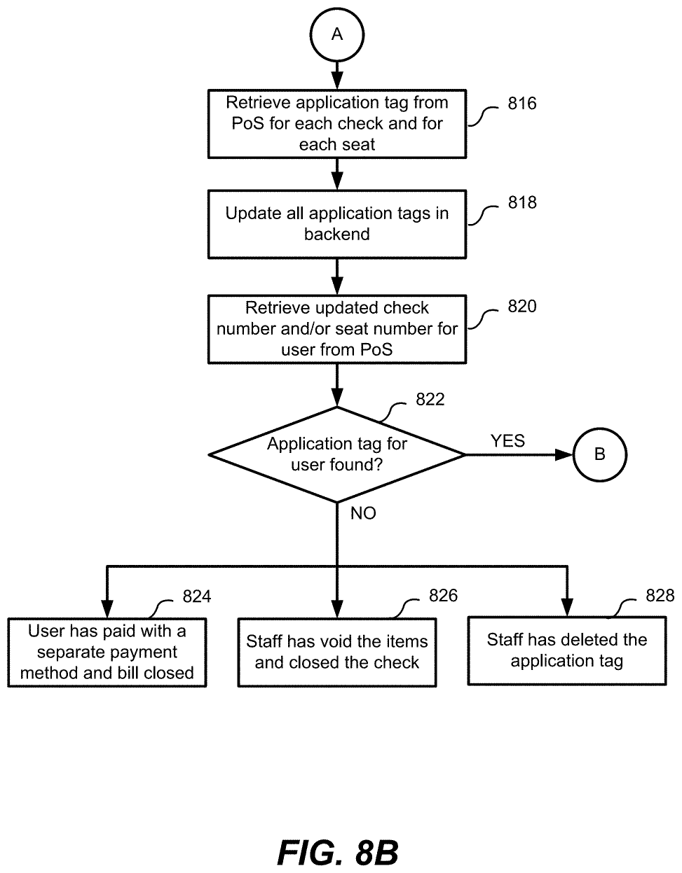

FIGS. 8A and 8B show a method for tracking a user's order while at an establishment. In particular, in some instances a user of the mobile application may change seats and/or tables while at the establishment (such as in the case of restaurants). The establishment staff may manually update the PoS accordingly, however the application tag assigned by the application backend to the respective open session may not be updated. As such, the application backend must find the correct open session to reassign the application tag for the user.

A user is associated with an open session (802). A check is created in the PoS with the user assigned a seat (and/or a table, and/or a different type of identifier depending on the establishment and the PoS system) (804). The check number and seat number for the user is received from the PoS (806). The user's application tag is associated in the backend to the check number and seat number (808). The user's application tag is also associated to the check number and seat number in the PoS (810).

The check number and seat number for the user is retrieved from the PoS (812). Such retrieval may be performed periodically at predetermined time intervals, or in response to certain events such as a user requesting to view their bill, the user requesting to settle their bill, etc. A determination is made if the user's tag assigned to the check and seat number in the PoS matches the user tag assigned to the check and seat number in the backend (814). If there is a match (YES at 814), it may be determined that the user has not moved tables/seats, and returns to retrieving the check number and seat number for the user (812) at the next predetermined time or next event.

If the user's tag for the check and seat number in the PoS does not match the user's tag in the backend (NO at 814), the backend retrieves all application tags from PoS associated with each check and for each seat number (816). All application tags are updated in the backend with the most recently retrieved check and seat number (818). The updated check number and seat number associated with the user's application tag is retrieved from the PoS (820). A determination is made if the application tag for the user is found (822). If the application tag for the user is found (YES at 822), the check number and seat number for the user is retrieved from the PoS (812) to confirm that the user's tag assigned to the check and seat number in the PoS matches the user tag assigned to the check and seat number in the backend (814). If the application tag for the user is not found (NO at 822), this suggests that the user has paid with a separate payment and the bill has been closed at the PoS by the establishment staff (824), that the staff has void the items ordered by the user and closed the check (826), or that the staff has deleted the application tag at the PoS system (828).

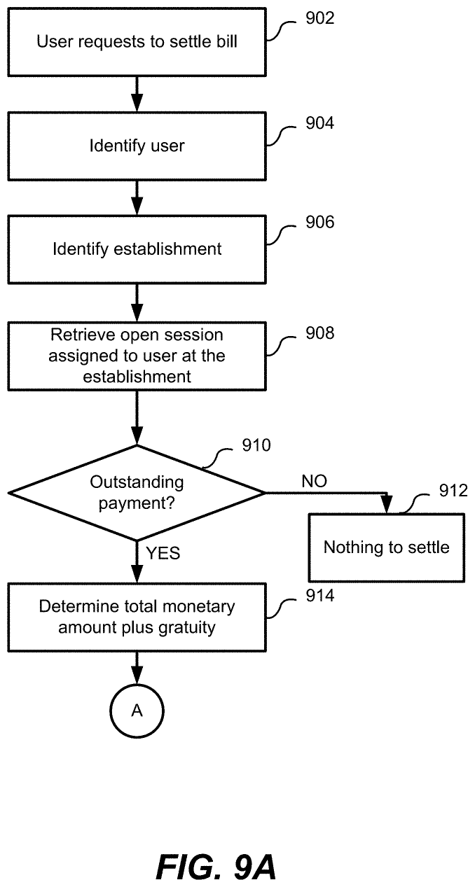

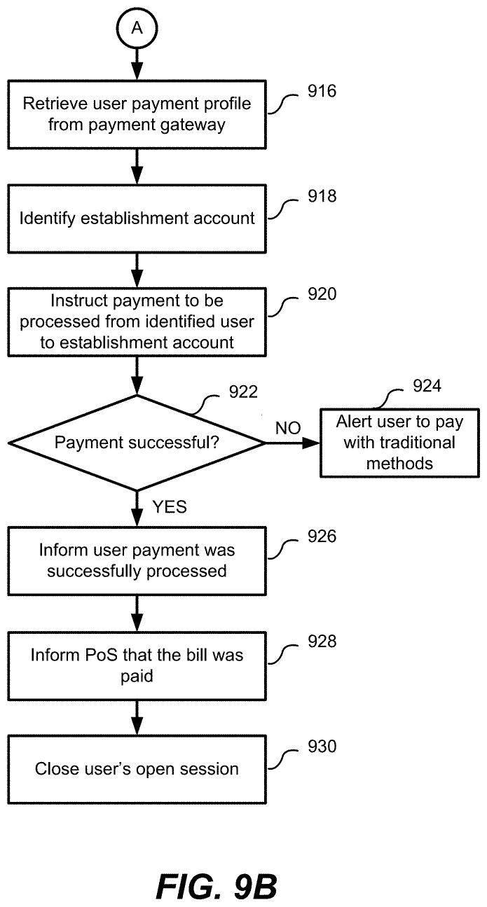

FIGS. 9A and 9B show a method of remotely processing a user's payment at an establishment. A user requests to settle their bill (902). The user is identified (904) and the establishment is identified (906). The backend retrieves the open session from the PoS assigned to the user at the establishment (908). In some implementations, the open session assigned to the user may be all open sessions associated with an identification equipment that was scanned or tapped by the user, from which the user can then select their bill. A determination is made if there is an outstanding payment for the goods/services ordered by the user (910). If there is no outstanding payment (NO at 910), the user is informed that there is nothing for the user to settle (912).

If there is an outstanding payment for the goods/services ordered by the user (YES at 910), a total monetary amount for the goods/services plus any gratuity is determined (914). A default gratuity may be added that the user can modify, or the user may be able to input the gratuity. The user payment profile is retrieved from the payment gateway (916). The establishment account stored in the payment gateway is identified (918). The backend instructs the payment gateway to process the payment by charging the user a payment for the goods/services to settle the bill and to deposit the payment in the establishment account (920).

A determination is made if the payment successful (922). If the payment is unsuccessful (NO at 922), the user is alerted to pay the establishment with traditional methods (e.g. cash, credit card at a payment terminal) (924). If the payment is successful (YES at 922), the user is notified that the payment was processed (926). The backend informs the PoS that the bill was paid (928) and the user's open session is closed (930). The user may also be e-mailed a receipt or have a receipt pushed to the application on their mobile device, for example.

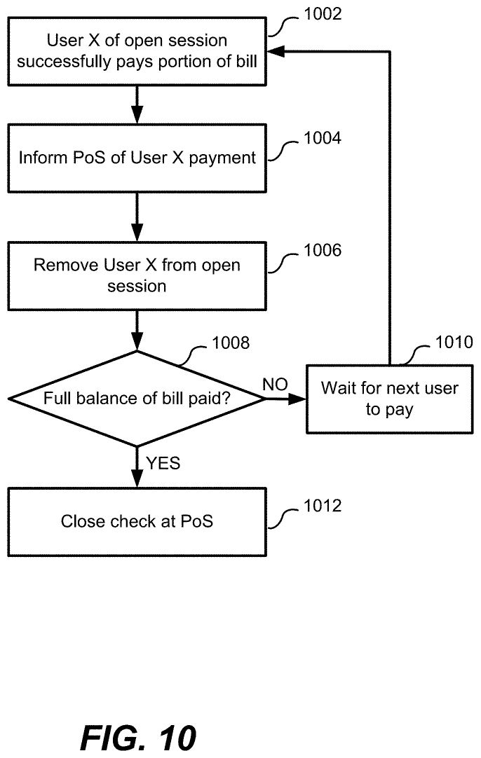

FIG. 10 shows a method of processing a collaborative bill payment. Where an open session has more than one user that are splitting a check the application backend processes payments from each of the users. Splitting a check may be indicated by instructing the establishment employee to put different items and/or splitting items between different seats/guests. Users of the mobile application may then see their own portion of the bill and will pay for that portion. Additionally or alternatively, users of the mobile application may themselves manage who pays for what. For example, people assigned to the same table using the mobile application may be able to send items to each other or portions of items to each other. For example, a first guest at a restaurant that is a user of the mobile application may order a chicken burger, chicken fingers, and one bottle of wine. Through the mobile application the user may send the chicken burger to a second guest and a half of the bottle of wine to a third guest seated at the same table. The second and third guests can accept the items sent through the mobile application, and will then be responsible to pay for them. Accordingly, when splitting a check the establishment staff may distribute items in a certain way and users of the application may modify the distribution. In some embodiments the application may provide a quick split functionality that allows all items to be split equally amongst the users.

A first user of the open session successfully pays their portion of the bill (1002). That is, the backend instructs the payment gateway to charge the first user a payment corresponding to their portion of the bill and the payment is successful. The PoS is informed of the first user's payment (1004) and the first user is removed from the open session at the PoS (1006).

A determination is made if the full balance of the bill has been paid (1008). If the full balance has not been paid, the backend waits for a next user (e.g. a second user) of the open session to pay (1010) and the backend instructs the payment gateway to change the second user a payment corresponding to their portion of the bill. Waiting for the next user to pay may comprise waiting to receive an indication from a user of the open session that they wish to settle their bill. Where a user has left the establishment without settling their bill, then the backend forces the user to pay. The second user of the open session successfully pays their portion of the bill (1002), the PoS is informed of the second user's payment (1004), and the second user is removed from the open session at the PoS (1006). When the full balance of the bill has been paid (YES at 1008), the check at the PoS is closed (1012). The users may also be e-mailed a receipt, for example.

The above-described method provides a particular implementation of bill splitting where each of the customers assigned to the open session are users of the application. In some embodiments, the customers assigned to the open session may comprise both users of the application and non-users of the application. Each guest pays for their portion of the bill. Non-users of the application may pay for their portion of the bill using traditional methods and/or via the webpage, while users of the application can pay for their portion in accordance with the embodiments disclosed herein (for example, leaving the establishment and being charged for their portion of the bill). When a bill comprises both users and non-users of the application, the establishment staff may distribute/split items between different seats/guests, while users of the application may modify the distribution of their portion by sending to other users of the application that are on the bill. The check at the PoS only closes once all items are paid for, regardless of how the items are distributed/split and who paid for what.

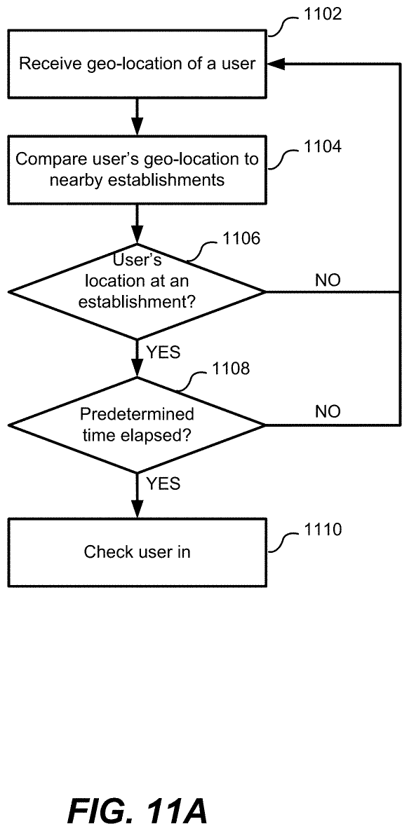

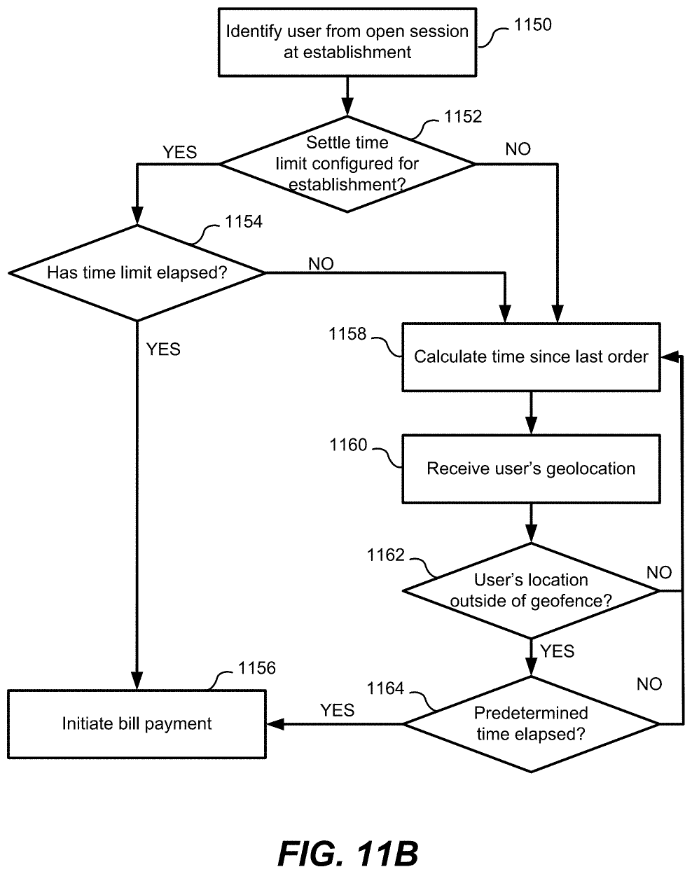

FIG. 11A shows a method of using a user's location to check-in at an establishment. A geo-location of the user is received (1102). For example, the application accesses a location of the user's electronic device and provides the location to the application backend. In some embodiments the user's location may be received at predetermined time intervals even when the user is not using the application. In some embodiments the user's location may be received when the user opens the application and/or is using the application. The user's geo-location is compared to nearby establishments (1104) and a determination is made if the user's location is at an establishment (1106). In some embodiments, the determination may be made based on whether the user's location is within a geo-fence of the establishment. If the user's location is not determined to be at an establishment (NO at 1106) the method returns to receiving the geo-location of the user (1102). If the user's location is determined to be at an establishment (YES at 1106) a determination is made as to whether a predetermined time has elapsed of the user's location being at the establishment (1108). If the predetermined time has not elapsed (NO at 1108) the method returns to receiving the geo-location of the user (1102). In this manner, if a user happens to be walking on a sidewalk in front of an establishment and passing by, the user will not be determined to have checked into the establishment. If the predetermined has elapsed where the user's location is determined to be at the establishment (YES at 1108) the user is checked into the establishment (1110).

As described with reference to FIG. 2, a geo-fence of the establishment and the predetermined time may be generic, or may be specifically configured for the establishment and stored with the establishment profile.

FIG. 11B shows a method of charging a user that has left an establishment before settling their bill. A user is identified from an open session at the establishment (1150). A determination is made if a settlement time limit has been configured for the establishment (1152). For example, a time settlement limit may be set for 2 hours from last item ordered. If a time settlement time limit has been configured (YES at 1152), a determination is made as to whether the time limit for the open session has elapsed (1154). If the time limit has elapsed (YES at 1154), the application backend initiates bill payment (1156) by charging the user via the payment gateway.

If there is no settlement time limit configured for the establishment (NO at 1152) or if there is a settlement time limit but the time limit has not elapsed (NO at 1154) a time since the user's last order is calculated (1158). The user's geolocation is also determined/received (1160). A determination is made if the user's location is outside of a geo-fence of the establishment (1162). If the user's location is outside a geo-fence of the establishment (YES at 1162), a determination is made if a predetermined time has elapsed (1164). If a predetermined time has elapsed (YES at 1164), or in other words, if the user is outside of the establishment's geo-fence and it has been some time since the user's last order, bill payment is initiated (1156) because it appears that the user has left the establishment's location. If the user's location has remained inside the geo-fence (NO at 1162) or a predetermined time since the last order has not elapsed (NO at 1164), the method returns to monitoring the time since the user's last order (1158). In this manner, if the user is at an establishment but has to return to their car in the middle of a meal, for example, the bill payment will not be initiated. In some embodiments, the user may also be determined to have left the establishment and bill payment should be initiated if the user's location is outside of the establishment's geo-fence for a predetermined time (not necessarily considering the time since the last order).

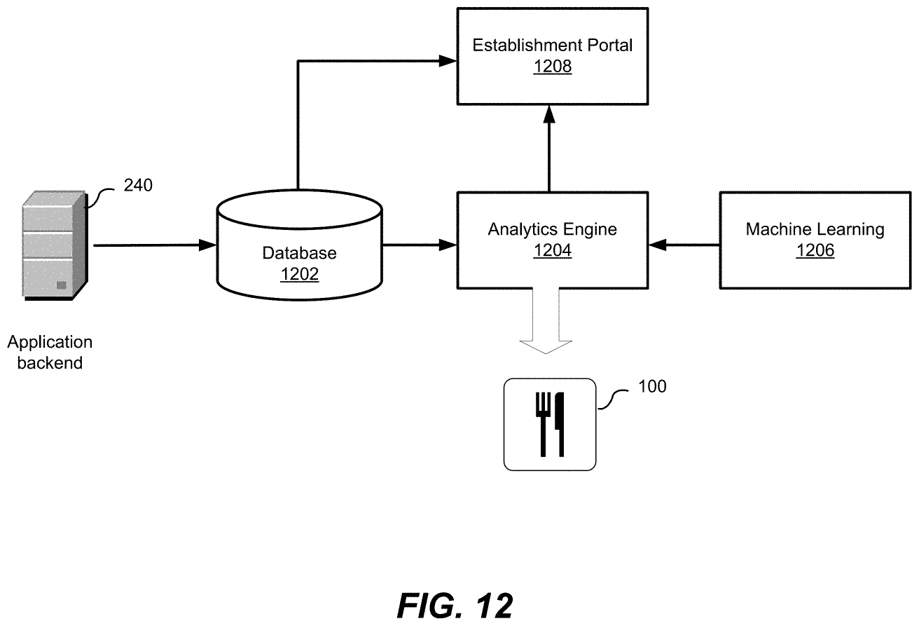

FIG. 12 shows a system for analyzing transaction data. Data from the application backend 240 is fed into a database 1202. Data in the database 1202 may be transformed, anonymized, and indexed. Certain data in the database 1202 may be accessible to establishment owners 100 via an establishment portal 1208. Analytics engine 1204 is configured to access the database 1202 and execute various algorithms on the data such as anomaly detection, forecasting, sentiment analysis, etc., to produce meaningful analytics for the establishment. The analytics engine may invoke various machine learning technologies such as IBM Watson™, Spark ML™, TensorFLow™, or DataBricks™ to create and train the algorithms for use in the analytics engine. The results of the analytics is provided to the establishment portal 1208, which may be an access-controlled UI.

In one non-limiting example implementation, the database 1202 may for example be a Mongo™ database. The oplogs and changelogs from the database may be read and put in an Elasticsearch™ cluster (in Elastic Cloud™ or in an AWS™ Elastic Service for example) for quick access indexed search. The data may be curated and transformed based on the different use cases (for example anomaly detection, forecasting and sentiment analysis). That data would be fed to the analytics engine 1204 for the algorithms to run according to the use cases.

It would be appreciated by one of ordinary skill in the art that the system and components shown in FIGS. 2-12 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

Although certain components and steps have been described, it is contemplated that individually described components, as well as steps, may be combined together into fewer components or steps or the steps may be performed sequentially, non-sequentially or concurrently. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the system and method described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor. to implement one, more or all of the steps of the described method or methods.

1. A server for processing customer payments for a plurality of establishments, comprising:
a communication interface for communicating via one or more communication networks;
a memory storing a plurality of user profiles associated with a corresponding plurality of users using a mobile application, and storing establishment profiles for each of the plurality of establishments; and
a processing unit configured to:
communicate via the communication interface with an electronic device running the mobile application and associated with a user profile among the plurality of user profiles;
communicate via the communication interface with native point-of-sale (PoS) systems located at each of the plurality of establishments remote from the processing unit; and
communicate via the communication interface with a payment gateway storing user payment information for each of the plurality of users and storing establishment account information for each of at least one establishment of the plurality of establishments.

2. The server of claim 1, wherein the server is distributed in a cloud architecture.

3. The server of claim 1, wherein the server is configured to receive check-in data of a user at an establishment from the electronic device through the mobile application.

4. The server of claim 3, wherein the check-in data is generated from user input or location data.

5. The server of claim 3, wherein the server is configured to remotely open a session for the user in the PoS system of the establishment that allows for goods/services ordered by the user at the establishment to be associated with the user.

6. The server of claim 5, wherein the server is configured to retrieve session information from the PoS system of the goods/services ordered by the user at the establishment.

7. The server of claim 6, wherein the server retrieves the session information in response to user input or from location data indicating that the user has left the establishment.

8. The server of claim 6, wherein the server is configured to settle a bill for the goods/services ordered by the user at the establishment by instructing the payment gateway to charge the user a payment to settle the bill and to deposit the payment in an account for the establishment.

9. The server of claim 1, wherein the server is configured to:
receive a request through the mobile application on the electronic device of a user to settle a bill and information identifying a user's location at an establishment;
retrieve session information from the PoS system for sessions associated with the user's location, and provide the session information to the electronic device of the user;
receive an indication through the mobile application on the electronic device of the user of a session corresponding to the bill; and
instruct the payment gateway to charge the user a payment to settle the bill and to deposit the payment in an account for the establishment.

10. The server of claim 9, wherein the information identifying the user's location at the establishment is generated from the user scanning or tapping identification equipment at the establishment using the mobile application.

11. The server of claim 1, wherein the server communicates with the native PoS system using one or more APIs for respective PoS systems.

12. A method of processing customer payments for a plurality of different establishments, comprising:
receiving a request from a mobile application on an electronic device of a user to settle a bill at an establishment;
identifying a user profile corresponding to the user and an establishment profile corresponding to the establishment;
retrieving session information from a point-of-sale (PoS) system of the establishment indicative of a bill of goods/services ordered by the user at the establishment; and
instructing a payment gateway, according to the user profile and the establishment profile, to charge the user a payment to settle the bill and to deposit the payment in an account for the establishment.

13. The method of claim 12, further comprising:
receiving check-in data of the user at the establishment from the electronic device through the mobile application; and
remotely open a session for the user in the PoS system of the establishment that allows for the goods/services ordered by the user at the establishment to be associated with the user.

14. The method of claim 13, wherein the check-in data is generated from user input or location data.

15. The method of claim 13, wherein the received request to settle the bill is generated in response to user input or from location data indicating that the user has left the establishment.

16. The method of claim 13, wherein a session is opened for the user in the PoS system is associated with an application tag for the user, and wherein the received request to settle the bill comprises the application tag.

17. The method of claim 12, further comprising receiving information identifying a user's location at the establishment, and wherein retrieving the session information from the PoS system comprises:
retrieving session information from the PoS system for sessions associated with the user's location;
providing the session information to the electronic device of the user; and
receiving an indication through the mobile application on the electronic device of the user of a session corresponding to the bill.

18. The method of claim 17, wherein the information identifying the user's location at the establishment is generated from the user scanning or tapping identification equipment at the establishment using the mobile application.

19. An integrative point-of-sale (PoS) system for an establishment, comprising:
an interface for receiving an input of goods/services ordered by customers of the establishment; and
a server for processing customer payments for the establishment, comprising:
a communication interface for communicating via one or more communication networks;
a memory storing a plurality of user profiles associated with a corresponding plurality of users using a mobile application associated with the establishment; and
a processing unit configured to:
receive the input of the goods/services ordered by customers; and
where a customer is a user of a mobile application:
communicate via the communication interface with an electronic device of the user running the mobile application;
retrieve a user profile from the memory corresponding to the user; and
communicate via the communication interface with a payment gateway storing user payment information for each of the plurality of users to instruct the payment gateway to charge the user a payment to settle a bill for the goods/services ordered by the user.

20. The integrative PoS system of claim 19, wherein the processing unit is further configured to process customer payments using traditional payment techniques when requested by a user of the mobile application and for customers who are not a user of the mobile application.
